(19) United States
(12) Patent Application Publication
(10) Pub. No.: US 2022/0099625 A1
(43) Pub. Date: Mar. 31, 2022

(54) APPLICATOR COMB WITH SERRATED TEETH FOR GEL ELECTROPHORESIS

(71) Applicant: HELENA LABORATORIES CORPORATION, BEAUMONT, TX (US)

(72) Inventor: Tipton L GOLIAS, Beaumont, TX (US)

(73) Assignee: HELENA LABORATORIES CORPORATION, BEAUMONT, TX (US)

(21) Appl. No.: 17/429,715

(22) PCT Filed: Feb. 10, 2020
(86) PCT No.: PCT/US2020/017409

§ 371 Date: Aug. 10, 2021

Related U.S. Application Data
(60) Provisional application No. 62/812,982, filed on Mar. 2, 2019.

(51) Int. Cl. G01N 27/447

(52) U.S. Cl. CPC G01N 27/44743; G01N 27/44747

(57) ABSTRACT

An applicator having a body and a series of teeth extending in a first direction from said body, the teeth spaced apart from each other in a second direction perpendicular to said first direction, each tooth having a base, a tip, and opposed sides, in which at least one tooth includes a series of serrations spaced apart from each other, each serration having a tip, and a base, and opposed sides and preferably being of generally trapezoidal shape. A method for depositing a liquid sample on a substrate using the applicator.

The disclosed product and method are related to the field of electrophoretic analysis of biological specimens, including the application of biological samples to an electrophoresis plate. More specifically, the present disclosed product and method are directed to a fluid applicator device and a method for depositing a liquid sample on a substrate utilizing the fluid applicator device for in situ electrophoretic analysis of biological specimens.

### BACKGROUND

In clinical laboratory practice, various techniques, such as electrophoresis, are used to apply samples to substrates for separation and analysis. Electrophoresis in general is the voltage-driven migration of suspended and/or colloidal particles in a liquid or a gel, due to the effect of a potential difference across immersed electrodes. In many devices that use electrophoresis, the strategy is to apply a sample just to the surface of a substrate, then apply a voltage to separate the components of the sample. This strategy is used in techniques like immunofixation-based electrophoresis and two-dimensional electrophoresis. Immunofixation electrophoresis is known from U.S. Patent Application Publication No. 2012/0052594. The use of an applicator comb with squared-off teeth is known from U.S. Pat. No. 6,544,395, and improvements in the applicator comb are known from U.S. Pat. No. 9,759,682. Gel electrophoresis systems and methods are known from WO 2013/181267 and U.S. Patent Application Publication No. 2012/0052594.

More specifically, electrophoresis is often used in the study of proteins and colloidal particles from biological samples, such as evaluation of lipoparticles and lipoproteins. In immunofixation methods, such as described in U.S. Patent Application Publication No. 2012/0052594, which is incorporated herein by reference in its entirety, a biological sample (e.g., serum) is applied to a substrate and the components are electrophoresed. Anti-sera containing labeled antibodies that target specific components of the blood is applied to the substrate. The antibodies attach to their antigen targets, and the targets can be identified through some means of detecting the label.

In clinical applications, it is desirable to analyze many samples in parallel on the same substrate. This reduces the cost per sample analyzed and saves substantial time. High throughput instruments and devices, such as the SPIFE 3000 Assay instrument by Helena Laboratories, are made for this purpose.

High throughput instruments use an applicator comb to apply a series of samples in a single line on the substrate. Such an applicator comb, having a design using squared-off teeth, is described in U.S. Pat. No. 6,544,395, which is incorporated by reference herein in its entirety. Further improvements in the applicator comb are described and illustrated in U.S. Pat. No. 9,759,682 which is also incorporated by reference herein in its entirety.

There continues to be a desire to increase the number of samples per substrate to increase the throughput, make the method more efficient and enhance the fluid control of each of the teeth in the comb. In this regard, fluid control refers to, among other things, (a) the amount of fluid retained by the teeth when each is inserted into a sample, (b) the amount of sample transferred by each into the gel, (c) the amount of antigen retained by each tooth when the teeth are inserted into a reservoir containing the antigen, and (d) the amount of antigen thereafter deposited onto the gel. An additional aspect of fluid control involves features such as the speed with which the desired amount of fluid (sample/specimen/antigen) is initially retained by the tooth and thereafter the speed or rate at which the desired amount of fluid is deposited or released by the tooth.

Changing the number of teeth in an applicator comb without a concurrent change in the width of the substrate provides a less desirable resolution since this requires a reduction in the size of each tooth the result of which is a loss of fluid control with smaller tooth dimensions. Also, structural integrity is lost when the tooth width is reduced, making each tooth more easily deformable during manufacture and when in contact with sample reservoirs and the substrate.

Simply making the teeth smaller to accommodate more samples non-reproducibly and inconsistently reduces the amount of sample per tooth deposited/transferred, lowering the ability to detect target components of the sample after they have been separated. Additionally, variable sample deposition with increasing the number of teeth per applicator comb can cause lane contamination so that adjacent lane samples bleed into one another rendering the samples as unreliable for measurement.

In previous efforts to generate a greater sample density on the gel, the teeth were manufactured to be narrower. However, a direct reduction in size/geometry led to inconsistent liquid management and generally reduced liquid deposition. The volume of the liquid to be applied must be of sufficient volume to accommodate the sensitivity of the assay. A narrower tooth must still have the ability to both load appropriate volumes and unload those volumes in a controlled and reproducible fashion. A narrower tooth without additional surface to adsorb the liquid will result in the liquid droplet surface protruding too far from the surface of the tooth, increasing the necessary surface tension to hold the liquid droplet in place. The flash dimension of each tooth is insufficient to maintain surface tension of the liquid droplet to prevent premature liquid release if the tooth is too narrow and no other provision is made to hold the liquid.

The present disclosure is directed to an applicator overcoming these and other deficiencies in the art.

### SUMMARY

One aspect of the present disclosure relates to a fluid applicator device including an applicator body having a surface that is generally planar. A plurality of aligned applicator teeth extends from the applicator body. Each applicator tooth extends longitudinally from the applicator body along a length from a base of the applicator tooth proximate to the applicator body to a tip of the applicator tooth distal to the applicator body. The applicator teeth are serrated.

Another aspect of the present disclosure relates to a fluid applicator including an applicator body with a series of teeth extending in a first direction from the body, the teeth being spaced apart from each other in a second direction perpendicular to said first direction, each tooth having a base, a tip, and opposed sides, with at least one tooth having a series of spaced apart serrations, each serration having a tip, a base, and opposed sides.

Another aspect of the present disclosure relates to a fluid applicator including an applicator body with a series of teeth extending in a first direction from the body, the teeth being spaced apart from each other in a second direction perpendicular to said first direction, each tooth having a base, a tip, and opposed sides, with at least one tooth having a series of spaced apart serrations, each serration having a tip, a base, and opposed sides with the serrations being of generally trapezoidal shape in which the tip is narrower than the base and preferably with the opposed sides each angled the same number of degrees relative to said first direction.

Yet another aspect of the present disclosure is an applicator as described having between 1 and 55 teeth, preferably 20, 25, 30, 35, 40, 45 or 50 teeth, and with at least one tooth being serrated with at least 1 and preferably 5, 10, 15 or 20 serrations.

Yet another aspect of the present disclosure is an applicator having teeth with the teeth having at least two serrations and with at least one of the following (a) a pitch of approximately 305 microns between serrations, (b) the at least two serrations have a height of approximately 230 microns, (c) a pitch between serrations being greater than the height of the serrations, (d) the ratio of a pitch between serrations to the height of the serrations being greater than about 1.25 and less than about 1.5 and preferably about 1.3, (e) the serrations having a thickness and a pitch between separations with the pitch being greater than the thickness, (f) the ratio of a pitch between serrations to the thickness of the serrations being greater than about 1.25 and less than about 1.75 and preferably about 1.5.

Yet another aspect of the present disclosure is a method for depositing a liquid sample on a substrate using an applicator having serrated teeth including the steps of first contacting the serrations with a liquid sample and thereafter depositing the liquid sample from the serrations onto the substrate.

Another aspect of the present disclosure relates to a method for depositing a liquid sample on a substrate comprising providing a fluid applicator device comprising an applicator body having a surface that is generally planar. A plurality of aligned applicator teeth extends from the applicator body. Each applicator tooth extends longitudinally from the applicator body along a length from a base of the applicator tooth proximate to the applicator body to a tip of the applicator tooth distal to the applicator body. At least one applicator tooth of the plurality of aligned applicator teeth is serrated at the tip. Each tooth of the applicator device is inserted into and removed from a supply volume of sample, thereby retaining a test volume of sample on each tooth. At least a portion of the test volume of sample is deposited onto a substrate by contacting the tips of the plurality of teeth of the fluid applicator device with the substrate. Thereafter, each tooth of the applicator device is inserted into and removed from a supply volume of fluid such as an antigen, thereby retaining a volume of fluid on each tooth. At least a portion of the volume of fluid is deposited onto a substrate by contacting the tips of the plurality of teeth of the fluid applicator device with the substrate.

The applicator of the present disclosure provides improved performance for sample loading, transfer, and deposition. The disclosure offers improvements in liquid management, including improved control of liquid flow during sample deposition. The disclosure further provides an applicator with a higher number of applicator teeth without loss of resolution, sensitivity or fluid transfer control. The higher number of applicator teeth improves efficiency in high throughput laboratories.

### BRIEF DESCRIPTION OF THE DRAWINGS

FIG. 1 is a front view of an embodiment of a fluid applicator device of the present disclosure.

FIG. 2 is a perspective view of an embodiment of a fluid applicator device of the present disclosure.

FIG. 3 is an enlarged front view of an individual tooth “A” of FIG. 1 for use with the fluid applicator device of the present disclosure; and

FIG. 4 is an enlarged perspective view of an individual tooth “B” of FIG. 2 for use with the fluid applicator device of the present disclosure.

### DETAILED DESCRIPTION

The present disclosure relates to a fluid applicator device and a method for depositing a liquid sample on a substrate using the fluid applicator device.

One aspect of the present disclosure relates to a fluid applicator device including an applicator body having a surface that is generally planar. A plurality of aligned applicator teeth extends from said applicator body. Each applicator tooth extends longitudinally from said applicator body along a length from a base of the applicator tooth proximate to the applicator body to a tip of the applicator tooth distal to the applicator body. At least one applicator tooth of the plurality of aligned applicator teeth has a serrated tip.

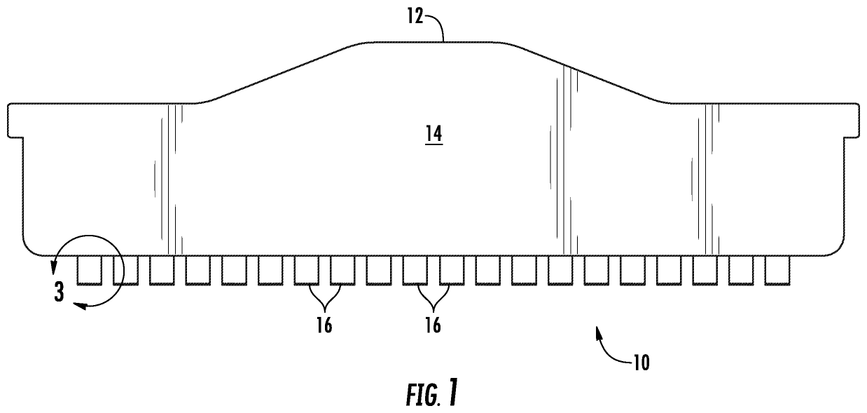

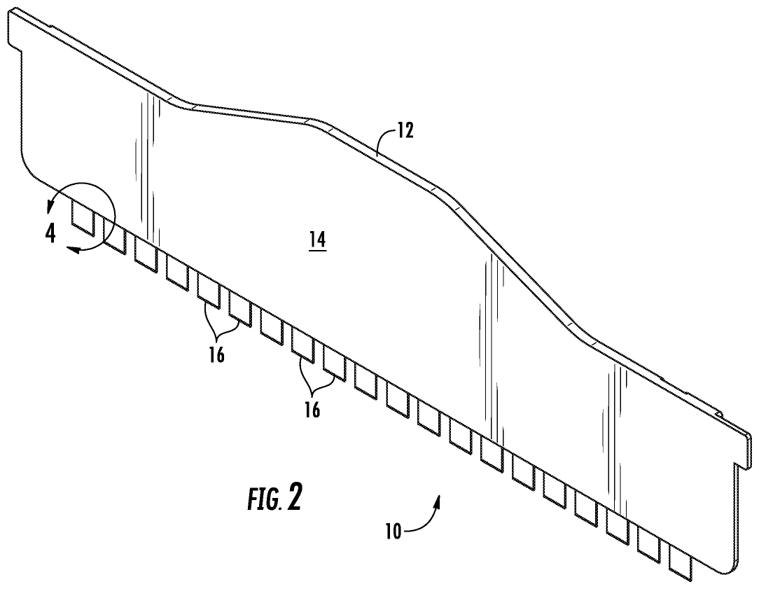

FIG. 1 is a front view of one embodiment of a fluid applicator device 10 of the present disclosure. FIG. 2 is a perspective view of one embodiment of a fluid applicator device 10 of the present disclosure. Fluid applicator device 10 may be used for the parallel application of samples to a gel substrate for gel electrophoresis applications. The fluid applicator device 10 as described herein may be used with any suitable gel electrophoresis system and/or method. Such gel electrophoresis systems and methods include, for example, those described in WO 2013/181267 and U.S. Patent Application Publication No. 2012/0052594, each of which is incorporated herein by reference in its entirety.

For example, the fluid applicator device 10 may be used in carrying out the step of depositing a sample in a receiving well of an electrophoretic gel as part of a method for performing electrophoresis. An exemplary method may be carried out with in-situ calibration and involve combining a volume of a test sample with a volume or quantity of a calibrating sample to form a final volume, in which the volume or quantity of the calibrating sample includes a known concentration of a calibrator and the final volume includes a known ratio of test sample to calibrating sample. The method also includes depositing a loading fraction in a receiving well of an electrophoretic gel, in which the loading fraction is a fraction of the final volume and separating the loading fraction along a common separation lane of the electrophoretic gel such that components of the test sample and the calibrator are separated from one another along the common separation lane. The method also includes detecting the calibrator and separated components of test sample within the common separation lane and measuring the level of the calibrator and separated components of the test sample based on the detecting, thereby performing electrophoresis with in-situ calibration.

As a further example, the fluid applicator device 10 may be used in carrying out the step of depositing a sample in a receiving well of an electrophoretic gel as part of a method for assessing the level of specific lipoprotein particles present in a bodily fluid, as described in U.S. Patent Application Publication No. 2012/0052594, which is hereby incorporated by reference in its entirety. The exemplary method involves separating lipoprotein particles present in a bodily fluid sample by gel electrophoresis on a gel electrophoresis substrate, exposing the substrate to an antibody to detect an immunologically active agent associated with lipoprotein particles or components of lipoprotein particles, exposing the substrate to a reagent for detection of the presence of proteins or lipids, and determining the level of specific lipoprotein particles.

Kits including the fluid applicator device 10 described herein together with a system for gel electrophoresis are also contemplated. For example, a kit for gel electrophoresis may include an assembly, system, or apparatus, as described in U.S. Patent Application Publication No. 2012/0052594, which is hereby incorporated by reference in its entirety, and a fluid applicator device as described herein.

A fluid applicator device 10 includes a handle 12, an applicator body 14, and applicator teeth 16, although fluid applicator device 10 may include other elements in other configurations. Handle 12 is used for manual or machine manipulation of fluid applicator device 10, as for example, described in U.S. Pat. No. 6,544,395, which is incorporated by reference herein in its entirety. Handle 12 may have holes, notches, slots, protrusions, or other features that facilitate handling and alignment of fluid applicator device 10 for the sample loading and sample deposition procedures, as described further below. In one example, the applicator handle and body may be integrally formed. In another example, applicator body 14 is rigidly attached to handle 12 using adhesive or glue. In a third example the applicator body 14 may be mechanically attached to handle 12 by tabs or other fasteners. Applicator body 14 may be constructed of a metallized polymer, such as aluminized polyester or Mylar™ Use of the metalized polymer for the applicator body 14 provides a hydrophilic surface over the hydrophobic polymer. In one example, applicator body 14 may have a width from about 0.2 cm to 11.5 cm.

Applicator body 14 includes a number of applicator teeth 16 aligned along and extending longitudinally therefrom. The applicator teeth 16 may be distributed along the width of the applicator body 14. Although applicator body 14 is illustrated with twenty applicator teeth 16 in FIG. 1 and FIG. 2, by way of example only, the fluid applicator device 10 may include a number of applicator teeth 16 in the range between 1 and 55, and the use of a greater number of applicator teeth 16 may be contemplated. In one example, fluid applicator device 10 includes at least (i.e., a minimum of) 20, 25, 30, 35, or 40 applicator teeth 16. In another example, fluid applicator device 10 includes up to (i.e., a maximum of) 45, 50, or 55 applicator teeth 16.

Applicator teeth 16 serve as an interface with sample wells and a sample substrate for deposition of a liquid sample on a substrate, as described further below. Each of the applicator teeth 16 is designed to carry and transfer a sample load of about 1 μl in the footprint of each tooth. Here, in a non-limiting example, the footprint consists of a two-dimensional interface corresponding to the blade of the tooth that is about 5 mm long bounded on both sides by a gap of about 5 mm between each adjacent tooth, although the footprint may have other dimensions. The teeth 16 each have a base 20 preferably located at the applicator body 14 and a free end distal from the applicator body. In one non-limiting embodiment, the height of a tooth “H” measured from the base 20 to the distal end may be about 2.54 cm (1.00 inches). In one non-limiting embodiment the width of a tooth “W” may be about 3.96 mm (0.156 inches) and a thickness “T” from the front surface of the tooth to the rear surface of the tooth of about 200 microns (0.008 inches). The width of each tooth is dependent on factors such as the width of the sample well and the width of the area on the substrate where the sample is to be deposited.

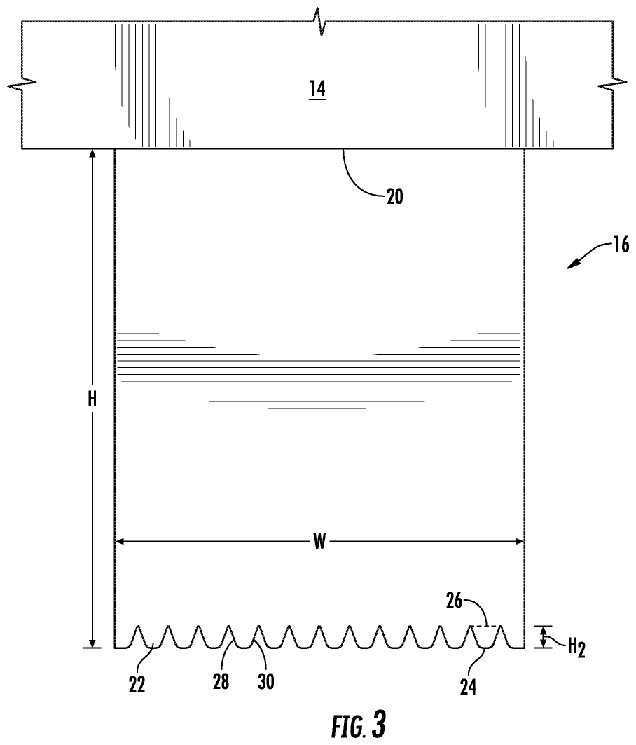

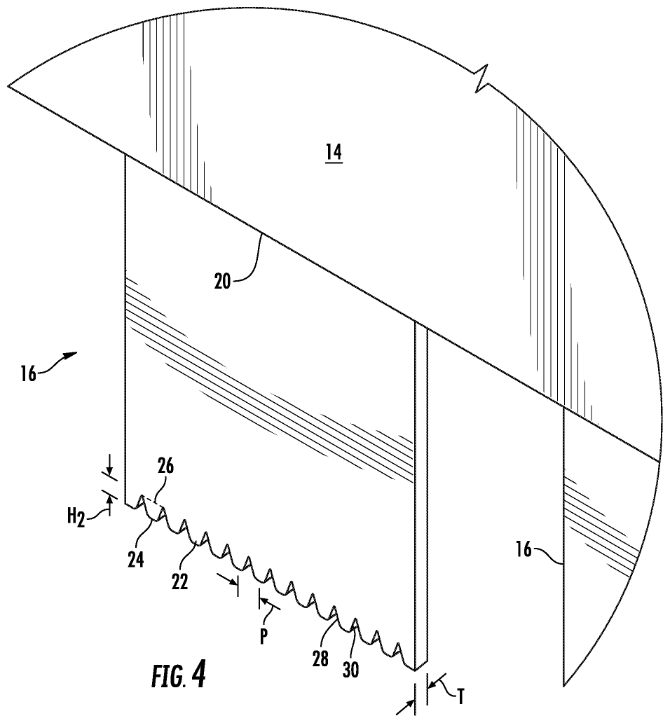

Having described the applicator body with a plurality of teeth, various representative non-limiting details of an individual tooth 16 will now be explained. FIG. 3 is an enlarged front view of a single tooth 16 “A” in FIG. 1 and FIG. 4 is an enlarged perspective view of a single tooth “B” in FIG. 2.

The quantities, shapes and measurements described are exemplary and non-limiting. At least one tooth 16 and preferably each tooth 16 is provided with a plurality of serrations 22 located at the distal tip and extending upwardly toward the base 20. A single serration 24 may have a height “H₂” of about 230 microns (0.009 inches) from the tip 22 to the top of the serrations illustrated as a broken line 26. A tooth may have 5, 10, 15, 20 or more serrations preferably equally distributed across the width of the tooth. The serrations are separated by a suitable pitch “P” of about 305 microns (0.012 inches) measured from one part of a serration to the corresponding part of an adjacent serration. For example, the pitch “P” may preferably be measured from the center of one serration to the center of the next adjacent serration. The serrations have a thickness “T” of about 200 microns (0.008 inches) from front to back illustrated in FIG. 4 corresponding to the thickness of the tooth. An individual serration 22 may be of generally trapezoidal shape extending from a serration tip 24 upwardly to a serration top 26 with opposed side edges 28, 30, each of which is at an angle of about 20° measured from the vertical. Thus, the angle between side edges of adjacent serrations is about 40°. The serrations thus appear as a series of notches at the tip of the tooth. The width of each serration 22, at the tip 24, may be about 50 microns (0.002 inches) and a preferred width of the space between adjacent serrations, which would be measured from one tip 24, at edge 28, to the adjacent tip 24 at edge 30, could be approximately 250 microns (0.010 inches).

A benefit of the present approach is that the total surface area of a serrated tooth (front, back and two angled sides) may be at least 50% greater and may be as much 90% or 95% greater than the surface area of tooth of the identical size (front, back and two vertical sides) without serrations. Thus, a greater and controlled amount of fluid will attach to the tooth and will thereafter be deposited on the gel when compared to the prior systems.

The applicator as described has at least two serrations with a pitch “P” therebetween and a height “H₂” with the pitch “P” being greater than the height “H₂.” The ratio of pitch “P” to the height “H₂” is preferably greater than about 1.25 and preferably less than about 1.5 and more preferably about 1.3.

The applicator as described has at least two serrations with a pitch “P” therebetween and a thickness “T” with the pitch “P” is greater than the thickness “T.” The ratio of pitch “P” to the thickness “T” is preferably greater than about 1.25 and preferably less than about 1.75 and more preferably about 15.

Although preferred embodiments have been depicted and described in detail herein, it will be apparent to those skilled in the relevant art that various modifications, additions, substitutions, and the like can be made without departing from the spirit of the disclosure and these are therefore considered to be within the scope of the disclosure.

1-14. (canceled)

15. An applicator having a body and a series of teeth extending in a first direction from said body, the teeth spaced apart from each other in a second direction perpendicular to said first direction, each tooth having a base, a tip, and opposed sides, wherein at least one tooth includes a series of serrations spaced apart from each other, each serration having a tip, a base, and opposed sides therebetween.

16. The applicator of claim 15, wherein each tooth includes a series of serrations.

17. The applicator of claim 15, wherein at least one serration is of generally trapezoidal shape in which the tip is narrower than the base.

18. The applicator of claim 15, wherein at least one serration has opposed sides angled relative to said first direction.

19. The applicator of claim 15, wherein a least one serration has opposed sides each angled the same number of degrees relative to said first direction.

20. The applicator of claim 15, having between 1 and 55 teeth.

21. The applicator of claim 15, wherein one tooth has between 1 and 20 serrations.

22. The applicator of claim 15, having at least two serrations with a pitch of approximately 305 microns therebetween.

23. The applicator of claim 15, wherein the at least one serration has a height of approximately 230 microns.

24. The applicator of claim 15, having at least two serrations wherein the serrations have a pitch “P” therebetween and a height “H₂” and wherein the pitch “P” is greater than the height “H₂.”

25. The applicator of claim 15, having at least two serrations wherein the serrations have a pitch “P” therebetween and a height “H₂” and wherein the ratio of pitch “P” to the height “H₂” is greater than about 1.25 and less than about 1.5.

26. The applicator of claim 15, having at least two serrations wherein the serrations have a pitch “P” therebetween and a thickness “T” and wherein the pitch “P” is greater than the thickness “T.”

27. The applicator of claim 15, having at least two serrations wherein the serrations have a pitch “P” therebetween and a thickness “T” and wherein the ratio of pitch “P” to the thickness “T” is greater than about 1.25 and less than about 1.75.

28. A method for depositing a liquid sample on a substrate using the applicator of claim 15, including first contacting the serrations with a liquid sample and thereafter depositing the liquid sample from the serrations onto the substrate.
